(19) United States
(12) Patent Application Publication
(10) Pub. No.: US 2009/0254886 A1
(43) Pub. Date: Oct. 8, 2009

(54) Virtual debug port in single-chip computer system

(76) Inventor: Gibson D. Elliot, Oak Run, CA (US)

Correspondence Address: HENNEMAN & ASSOCIATES, PLC, 70 N. MAIN ST., THREE RIVERS, MI, 49093, US

(21) Appl. No.: 12/220,459

(22) Filed: Jul. 24, 2008

Related U.S. Application Data
(60) Provisional application No. 61/042,111, filed on Apr. 3, 2008.

(51) Int. Cl. G06F 9/44

(52) U.S. Cl. 717/125; 717/128

(57) ABSTRACT

The invention is a method and apparatus for debugging of software on an array-type single chip computer system 16 without provision of dedicated debugging hardware on the chip. This is accomplished by suitable operating instructions that cause a hardware portion of array 16 to operate as a virtual background debug mode port 10 for one 12 and more hardware portions in the array. Virtual debug port 10 communicates with an adjacent target hardware portion 12 via their common directly connected single-drop bus 16, and with an external user interface system through an input/output (I/O) port 28, by passing the debugging information through other hardware portions 52 of the array to a peripheral hardware portion 22 adapted with the I/O port 28. The method of the present invention includes a retriever program, sometimes called a “head segment”, operating in the virtual debug port hardware portion, and further software portions referred to as “stream segment” and “tail segment” which are resident and operating in other hardware portions of the array and which interoperate cooperatively with the retriever program to implement communication of data and instructions between the virtual debug port and the user interface. The method includes a portion referred to as “delivery segment” which is prepared by the user and transmitted from the user interface system to the chip, and contains the head segment, stream segments, and tail segment programs as a payload, which it delivers and stores in appropriate other hardware portions of array 16.

### RELATED APPLICATIONS

This application claims the benefit of provisional U.S. Patent Application Ser. No. 61/042,111 filed on Apr. 3, 2008 entitled “Multicore Debug Method” by at least one common inventor which is incorporated herewith by reference in its entirety.

### BACKGROUND OF THE INVENTION

1. Field of the Invention

This invention relates generally to data processing software development, and more particularly, to processes and apparatus for debugging of computer programs on computer systems on a single microchip.

2. Description of the Background Art

Testing and debugging of software is a necessary part of software development for application of a computer or a computer system to perform a useful task. Debugging is known in the art for a wide range of computer technology and is conventionally performed using pre-existing breakpoints in a debug mode of a target software program (of instructions), and a user interface that interacts with a computer performing the target program, over an externally-connected communication path or bus and dedicated testing circuits on the computer chip, using the computer's command language. The present invention is directed to debugging of software for a particular type of computer system, one that has a parallel-distributed structure at the hardware level, comprising a plurality of substantially similar hardware portions disposed as an array on a single microchip (also known as a die), employing direct connection between adjacent portions, without a common bus over which to address individual portions on the chip. Generally each hardware portion includes a set of functional resources that is the smallest repeated element of the array. One known form of such a computer system is a single-chip multiprocessor array, comprising a plurality of substantially similar directly-connected computers, each computer having processing capabilities and at least some dedicated memory. Moore, et al. (U.S. Pat. App. Pub. No. 2007/0250682 A1) discloses such a computer system. This design approach has proven advantageous in terms of operating speed and power saving, especially in real-time embedded control and signal processing environments, which are increasingly important fields of computer application.

Debugging of software in this technology area has special requirements. Information on the details of gate-level and register-level operation of instructions and timing is important for developing and verifying correct operation of real-time applications for embedded systems on a single microchip. One must reach inside a device of submicroscopic dimensions and millions of parts to observe its operation without altering the functioning. In order to obtain such information, prior-art debugging techniques have relied on dedicated on-chip testing circuits such as BDM (background debug mode) and JTAG ports, and on bond-out versions of a. chip built specifically for debugging, to provide special external connectivity, but these known methods have shortcomings and limitations. Dedicated testing circuits and interfaces are wasteful of chip area and external connector pad space, as they cannot be reconfigured for other tasks. Special chip versions are undesirable because of cost, especially in latest-generation semiconductor technology employing small feature size and complex chip processing. A need exists for novel debugging methods and apparatus that avoid these prior art shortcomings.

### SUMMARY OF THE INVENTION

Accordingly, it is an object of the present invention to provide a method and apparatus for debugging of software on an array-type single chip computer system without the need for dedicated on-chip testing circuits and interfaces, resulting in more efficient use of chip area, lower power, and greater speed of operation. It is still another object of the invention to provide for such debugging without requiring bond-out versions of the chip, resulting in a significantly reduced cost of development. The array-type single chip computer system to which this invention is directed has a parallel-distributed structure at the hardware level, comprising a plurality of substantially similar hardware portions disposed as an array; with direct connection between adjacent array elements; and no common bus for addressing individual elements. The hardware portion that is the smallest repeated element of the array can be a computer, and alternatively, a set of computation, communication, and memory resources.

Briefly stated, the present invention is a method and apparatus for debugging of software on an array-type single chip computer system without provision of dedicated debugging hardware on the chip. This is accomplished by suitable software (operating instructions) that cause a hardware portion of the array to operate as a virtual background debug mode port (local debugging interface circuit) for one or more other (target) hardware portions in the array. The virtual debug port communicates with an adjacent target hardware portion via their common directly connected single-drop bus, and with an external user interface system through an input/output (I/O) port, by passing the debugging information through other hardware portions of the array to a peripheral hardware portion (on the edge of the chip) adapted with the I/O port.

The software, according to an embodiment of the method of the present invention, includes a retriever program sometimes also called a “head segment”, operating in the virtual debug port hardware portion, and further software portions referred to as “stream segment”, and “tail segment” which are resident and operating in other hardware portions of the array and which interoperate cooperatively with the retriever program to implement communication of data and instructions between the virtual debug port and the user interface. The software further includes a portion referred to as “delivery segment”, which is prepared by the user and transmitted from the user interface system to the chip, and contains the head segment, stream segments, and tail segment programs as a payload, which it delivers and stores in appropriate other hardware portions of the array.

### BRIEF DESCRIPTION OF THE FIGURES

FIG. 1 is a symbolic block diagram of a virtual debug port in a multiprocessor array, according to the present invention, connected to a user interface system on a host computer.

FIG. 2 is a symbolic view of a multiprocessor array in greater detail illustrating a virtual debug port adjacent a target processor, according to the invention.

FIG. 3 is a symbolic view illustrating an alternate embodiment wherein the virtual debug port is not adjacent to a target processor.

FIG. 4 is a flow diagram of a typical debugging session, according to the method of the invention.

### DETAILED DESCRIPTION OF THE FIGURES

The inventive virtual debug port is depicted in block diagram and symbolic view in

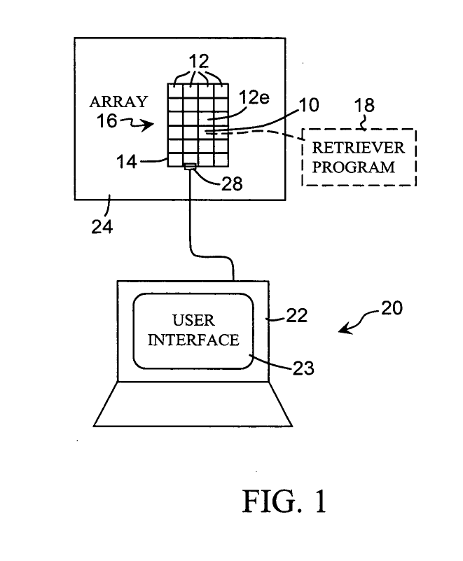

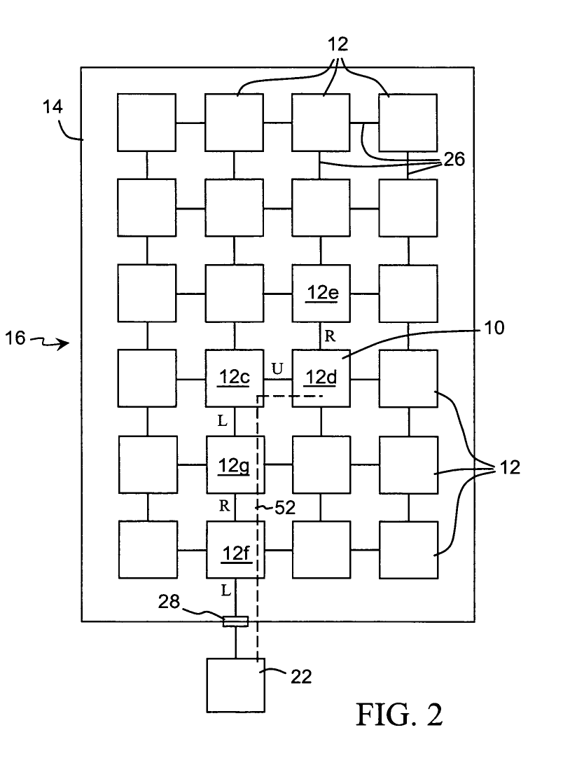

FIG. 1 and is designated therein by the general reference character 10. According to this embodiment of the invention, the virtual debug port 10 is a computer 12 that is one of a plurality of substantially similar computers 12 (sometimes also referred to as processors, cores, or nodes) located on a single microchip 14, and is executing a program of instructions, herein referred to as “retriever” 18. The plurality of computers comprising an array 16 of computers are interconnected and adapted to operate as a multiprocessor computer system. In some cases depending on the application, all the computers may not be substantially similar and some of the 10 computers in array 16 can have additional or different circuit portions compared to other computers; for example, a computer on the periphery of the chip can have a circuit portion adapted to communication with devices external to the chip, through an I/O port, however, other purposes for such different circuit portions can also exist. The virtual debug port 10, by executing the retriever program 18, sometimes also referred to as a diagnostic forthlet, thereby interacts with a target program on an adjacent, neighboring computer 12e, herein referred to as the “target” computer, and collects and transmits back debugging information requested by a user, typically the software developer, through intermediate computers forming a communication path 52 sometimes also referred to as a “wire” on microchip 14, shown in FIG. 2 and through an I/O port. The virtual debug port 10 can be connected to a user interface system 20 external to the microchip 14, which includes suitable software and a host computer 22, sometimes also referred to as a PC (personal computer) or a terminal, for communicating with the user. Chip 14, holding array 16, can be attached in this embodiment to a processor board 24 also referred to as a circuit board, evaluation board, or in-system-programmable environment. One skilled in the art will recognize that there will be additional components on microchip 14 and board 24 that are omitted from the view of FIG. 1 for the sake of clarity. Such additional components include power buses, external connection pads, and other such common aspects of a microprocessor chip and processor board.

In one embodiment of the invention, adjacent, neighboring computers 12 can be directly connected to each other by individual single-drop buses 26, as illustrated in FIG. 2, and can operate asynchronously both internally and for communicating with each other and with external devices. According to an embodiment of the invention, a single-chip SEAforth®-24A Embedded Array Processor can serve as array 16. Computers 12 of such a processor array, sometimes also referred to as C18 cores, employ a dual-stack design with one “data stack” and one “return stack”, 18-bit word size, have individual ROM and RAM memory, and are adapted to execute native (machine) Forth language instructions and to use Forth words (also known as subroutines and programs), dictionaries of Forth words, and forthlets, sometimes collectively referred to as “Forth code”. These and other aspects, and operation of such a processor array, are described by Moore in publicly available material.

The inventive virtual debug port 10, interoperating with the user interface system 20, enables a software developer to observe, record, and interact with an individual (target) computer 12 on chip 14, while that computer executes a program of instructions that is the target of debugging and development—without the need of dedicated on-chip debugging and testing circuits and bond-out versions of the chip, as will be described in greater detail hereinbelow. The anticipated use of the virtual debug port 10 and user interface system 20 is to test and modify the target program of instructions (software) operating in the multiprocessor array 16 on chip 14, in order to detect and correct mistakes, and improve the target program and optimize it for an application.

The user interface system 20 on host computer 22 generally includes both hardware and software components functionally involved in the debugging operation, such as a debug program operating on the PC with a command line interface or a graphical user interface window 23 displayed on the monitor of host computer 22, an instruction compiler, an array simulator, and a communication port that can employ one of the known standards, for example USB, RS-232, and SPI. Connection to and communication between the host computer 22 external to chip 14, and computers 12 on chip 14, including the virtual debug port 10, can proceed through a computer located on the periphery (edge) of the array 16 and chip 14, which computer is adapted with an I/O (input/output) port, sometimes also referred to as an external I/O port; in the embodiment shown in FIG. 2, an I/O port 28 and computer 12f can be employed for such connection and communication. In alternate embodiments, these communication ports may use a standard or a custom serial communication technique, and still alternatively, they can operate a wireless connection and yet alternatively, a parallel connection, or a combination thereof can be used. It will be recognized by those familiar with the art that in yet another alternate embodiment the I/O port 28 can be adapted with associated circuitry on the chip 14, which is not included in a computer 12, and can include one external connection wire, also referred to as a pin, and alternatively, a plurality of connection wires or pins. In still another alternate embodiment, a plurality of I/O ports and user interface systems can be employed.

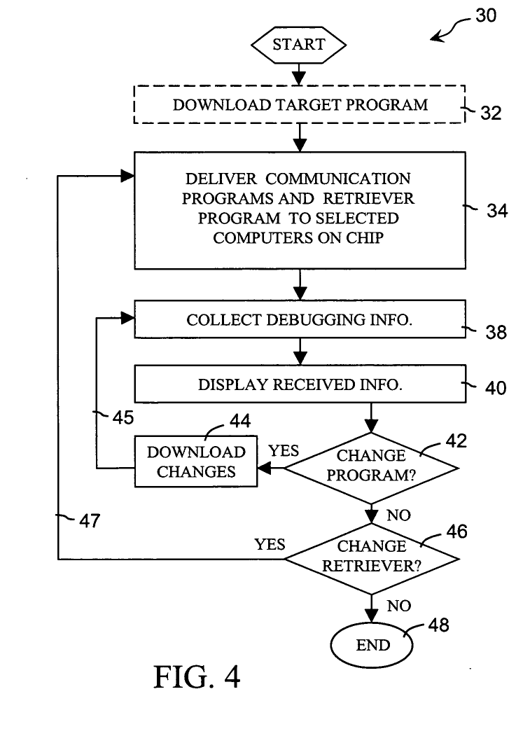

Operation of the virtual debug port 10 and retriever program 18 will be described with reference to a first example debugging session and EXAMPLES of Forth instructions operative in computers 12 of array, and with reference also to FIG. 2, which illustrates an embodiment of the array 16 in greater detail. A typical debugging session follows a general sequence of steps 30 of operation, according to an embodiment of the method of the invention, as shown in FIG. 4, in flow diagram form. In a first step 32, an application program of instructions that is the target of debugging is downloaded from host computer 22 to array 16, in an initial boot process, as known in the art. In this example, it will be assumed that the target of debugging is a program of instructions (software) in computer 12e, shown in FIG. 2. The target software can be a portion of an application program stored (and executing) in computer 12e, other portions of which are resident in other computers of the array, and alternatively, the target software can be a smaller whole target program operating in a single computer of the array, according to the size of the application and its disposition among the computers of the array.

In a second step 34, in the first example debugging session, a virtual debug port 10 and associated data communication path 52 are prepared in selected computers 12 of array 16, by downloading appropriate programs of instructions and data from the user interface and delivering them to the selected computers. The virtual debug port 10 is prepared in a computer located adjacent to and neighboring the target computer 12e, by delivering a retriever program 18, herein also referred to as a “head segment”, into the selected computer, from the user interface. The term “segment” herein refers to a Forth language program of instructions and data, which generally is adapted to interoperate with other segments. Data communication path 52 is prepared in a peripheral computer adapted with an I/O port, and in interior computers disposed between the peripheral computer and the virtual debug port computer, by delivering appropriate program segments to selected computers. The user who is operating the debugging session will in most cases have some latitude, depending on the application, to select the particular adjacent computer wherein to set up the virtual debug port, and other computers wherein to set up the communication path. It will be assumed in this example that the virtual debug port 10 is set up in computer 12d, which is disposed adjacent to the target computer 12e, and that the data communication path 52 will be set up in peripheral computer 12f, which is adapted with I/O port 28 connecting to host computer 22, and in intermediate computers 12f, 12g, and 12c, as shown in FIG. 2. Alternatively another I/O port and peripheral computer, and other intermediate computers, may be employed in the communication path, according to the application. The communication path instructions in peripheral computer 12f are herein referred to as a “tail segment”, and the communication path instructions in intermediate computers 12g and 12c, and in alternate embodiments also in others of a plurality of intermediate computers, are herein referred to as a “stream segment”.

Retriever 18 and tail and stream segments comprising suitable Forth code instructions may be downloaded to chip 14 and computers 12d, 12f, 12g, and 12c, respectively, together with the application program, as part of an initial boot process, by means of suitable booting instructions.

Alternatively, retriever 18 and the tail and stream segments can be delivered by a custom program, also called a “delivery segment”, which can transfer, store, and load a program of Forth language code from the user interface system at a later time, after completion of the boot process for the target application program. The delivery segment is prepared by the user with the aid of software components in host computer 22 and is, in this embodiment, transmitted to I/O port 28 on microchip 14 as a serial bit stream of digital information, generally comprising both instructions and data, and having a given length, which can be decoded into a respective number of 18-bits long words in computer 12f. The information which is transferred (delivered) will be referred to herein as a “payload” or “stream”. The term “deliver” as used herein can include storing a program at the location of delivery and loading it (causing it to begin executing) at the location where it is delivered. Appropriate “wrapper” instructions and data are included before and after the payload in a delivery segment, to provide for handling of the payload by the computers. The direction of data transmission from the I/O port toward the virtual debug port will herein be sometimes referred to as “downstream” and the direction from the virtual debug port toward the I/O port, as “upstream”.

An example of a delivery segment to deliver a payload from I/O port 28 to computers 12f, 12g, 12c, and 12d is illustrated in EXAMPLES 1 and 2, with reference also to Moore, et al. (id.), and to SEAforth®-24A Embedded Array Processor Device Data Sheet (Preliminary Version 1.1, Mar. 7, 2008) published by IntellaSys®, herein after referred to as Data Sheet. It should be noted that the word “port” is used in the references and herein also to denote one of a plurality of communication interfaces (also called “direction ports”) of a computer 12 of array 16, through which it connects (via single drop buses 26) to adjacent, neighboring computers 12; and further, that in the embodiment described, a computer 12 can have up to four ports, named R, D, L, and U connecting to adjacent computers. For purposes of this example, computers 12f, 12g, 12c, 12d forming path 52, and computer 12e forming the virtual debug port 10, can be identified, respectively, as computers N12, N13, N14, N08, and N09, shown in the Data Sheet (id.) (FIGS. 1.1 and 4.1), and their port names are specified in FIG. 4.1 (id.). For ease of reference, the port names of the particular ports interconnecting the computers along path 52 are denoted in FIG. 2. It is assumed for purposes of these examples that after power-up there are PAUSE instructions in the software executing in the computers along path 52, which cause a computer to be asleep but alert, and adapted to be awakened by a write to one of its ports and to execute instructions from that port. In one embodiment of array 16, PAUSE can be a Forth word, for example “Warm”, stored in ROM for example at address $0ac (as part of a set of Forth words sometimes collectively referred to as BIOS), that continuously looks for write requests from neighboring computers to any of the ports of a computer, by examining the port status (IOCS) register which is continuously updated, and places the port address of the first write thus found into the Program Counter register, described in the Data Sheet (id.), as the address from which the computer 12f will obtain its next instruction (sometimes referred to as “port execution”). For example, “Warm” in computer 12g can find a write request on port R, and cause 12g to begin executing instructions written by a program in neighbor computer 12f and ending with a RETURN instruction, which will return control to computer 12g. Another Forth word FetchSegrnentFromPort in ROM of a peripheral computer can look for a logical high applied to an appropriate external connection pin of its I/O port, determine the bit rate of serial information received, and convert (de-serialize) received serial data to 18-bit words on the data stack. In one embodiment, a high voltage applied to bit-17 pin of I/O port 28 can awaken computer 12f by causing the ROM word FetchSegrnentFromPort to be executed, in place of port execution. A beginning section of the serial data stream, included in a wrapper before the payload, can be used by a subroutine IOwake to establish the bit rate, and subsequent serial data can be converted (de-serialized) one word at-a-time into 18-bit words on the data stack by another subroutine @Serial and further processed by Forth instructions, in FetchSegmentFromPort, as shown in EXAMPLE 1.

### EXAMPLE 1

\ delivery segment (serial I/O, 12f)
12f {node
: FetchSegmentFromPort

| | |
|---|---|
| IOwake | \ called by high voltage on bit-17 pin |
| @Serial | \ determines bit rate of serial data stream |
| | \ de-serializes bit stream to one 18-bit word |
| | \ on data stack, acknowledges and loads |
| | \ new word at every call. |
| | \ receive constants MEM_F, TAIL_CT |
| dup push a! | |
| @Serial | |
| Push | \ leaves MEM_F in the return stack |
| | behind TAIL_CT |
| begin | |
| @Serial | |
| !a+ next | \ loop to receive and store a first portion |
| | of payload |
| @Serial | \ receive constants PORT_G, PL1_CT |
| b! @Serial | |
| push | |
| @p+ dup | |

@p+ dup push @p+

| | |
|---|---|
| !b !b | \ wakes up downstream computer 12g |
| begin | |
| @Serial | |
| !b next | \ loop to receive and transmit a second |
| | portion of payload |
| ; | \ returns to execute instructions at address |
| | MEM_F |
| node} | |

An embodiment of FetchSegmentFromPort requires four constants of wrapper data in the payload, a first constant, MEM_F, which is the local storage address (in RAM) for a first portion of the received payload comprising a tail segment to be loaded into computer 12f; a second constant, TAIL_CT, which specifies the length or size of the first portion, expressed as an 18-bit word count; a third constant, PORT_G, which specifies the port address for transmission of a second, remaining portion of payload to a first neighboring computer along path 52; and a fourth constant, PL1_CT, which specifies the size of the second portion. The first two constants can be placed before the first portion of the payload, and the second two, before the second portion, as shown hereinabove in EXAMPLE 1. Here, PORT_G=$1d5, the address of port R. It is assumed in this example, that the computers 12f-12d can begin executing respective communication path and retriever instructions (segments) delivered to and stored in their local memory, after the delivery segment completes execution in the computer; for example, computer 12f can begin executing a tail segment program at RAM address MEM_F, after FetchSegmentFromPort completes execution in 12f.

A second portion of payload delivered to subsequent computers along path 52, illustrating an embodiment of wrapper instructions and data operative to execute from a port, is described in EXAMPLE 2, in this case for computer 12g executing instructions transmitted by computer 12f to its port R to store a first sub-portion of payload, and transmit a second sub-portion of payload to computer 12c.

### EXAMPLE 2

\delivery segment, executed in 12g (from port R)

| | |
|---|---|
| @p+ dup push @p+ | \ first instruction word transmitted from 12f |
| MEM_G | \local storage address for stream segment in 12g |
| STREAMG_CT | \size of stream segment |
| push a! . . | |
| @p+ !a+ unext | \micro-loop to receive and store a first sub-portion |

| | |
|---|---|
| $\begin{matrix}• \\ • \\ •\end{matrix} \}$ | \ of the payload, comprising stream \ segment data and instructions transmitted \ from 12f to port R of 12g, for execution in 12g |
| \ | |

| | |
|---|---|
| @p+ b! @p+ • | \receives constants specifying next port address |

| | |
|---|---|
| PORT_C | \ and size of remaining payload portion |
| PL2_CT | \ for further delivery along path 52 |

push @p+ dup •

@p+ dup push @p+

| | |
|---|---|
| !b !b • • | \wakes up next computer 12c |
| @p+ !b unext | \micro-loop to receive and transmit remaining |
| | \ payload portion to 12c |

| | |
|---|---|
| $\begin{matrix}• \\ • \\ •\end{matrix} \}$ | \ \remaining payload portion of instructions |
| | \ and data, containing stream segment |
| | \ for 12c, retriever 18 for 12d, and suitable |
| | \ wrapper instructions and data, goes here |
| ; • • • | \returns 12g to execute instructions at |
| | \ address MEM_G |

It should be apparent to those familiar with the art that delivery segments for intermediate computers, such as 12c, to be executed from a respective upstream port along path 52, which are included in a remaining payload portion, can be substantially similar to that shown in EXAMPLE 2, with appropriate changes made to the constants. In each case, in this embodiment, the delivery segment will include a portion of data and Forth instructions stored locally, and a payload portion transmitted to the next computer along path 52. As path 52 ends at computer 12d, the last payload portion delivered is retriever 18, which stored in local memory of computer 12d. It will be further recognized that the results described hereinabove may be accomplished by other combinations of Forth instructions, without departing from the spirit of the invention. The delivery segment may be configured to deliver a single retriever program 18 (as in this example) and alternatively, a plurality of retriever programs (providing a plurality of virtual debug ports 10 on one chip 14), which can be independent of each other, and still alternatively, coordinated with each other.

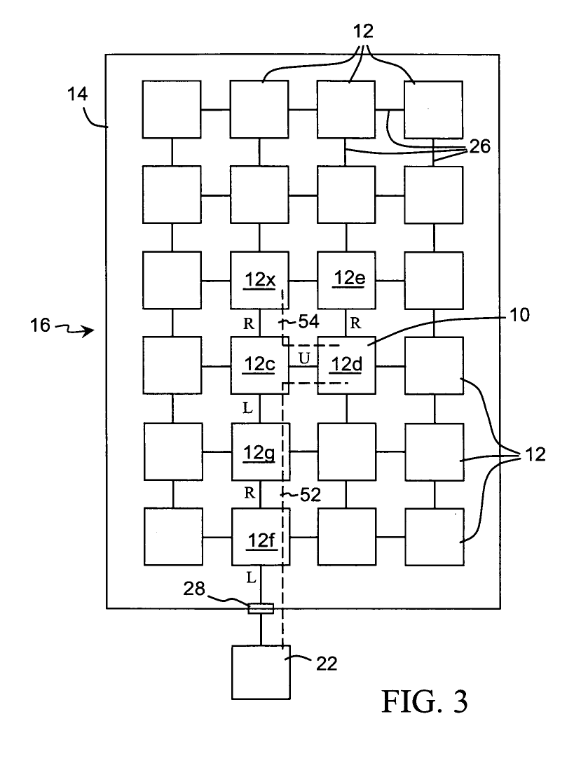

Yet further alternatively, it may be desirable to have a retriever program 18 (and virtual debug port 10) located in a computer of the array that is not adjacent to a target computer. For example, for debugging a target program that is running on two (or a greater plurality of) adjacent computers, it may be desirable to use only one virtual debug port 10 adjacent to one of the computers for debugging of target software stored and executing in both computers. FIG. 3 shows such an alternate embodiment wherein a virtual debug port is set up in computer 12d, for debugging of software in a target computer 12x that is not adjacent to the virtual debug port. Generally this will require communication between the virtual debug port and the target computer to be extended (passed) through intermediate computers, in this case, through computer 12c, as will be further described hereinbelow.

An example of a tail segment operating in computer 12f, to transmit a single payload of debugging information (data) back to host computer 22, for example to be displayed in graphical user interface window 23, is illustrated in EXAMPLE 3, showing the computer 12f waiting in a port read for the incoming debugging data along the communication path 52 (in this example, from computer 12g) and transmitting it out through I/O port 28, when received.

### EXAMPLE 3

\ tail-segment (static recipient, in 12f)

| | |
|---|---|
| ‘R--- #b! | \ Points B-register to port R receiving data. |
| MEM_BUFF # dup a! | \ Points A- register to local memory address, |
| | \ and leaves copy of address on stack. |
| DEBUG_CT # dup | \ Sets payload size for incoming |
| | \ debugging data and leaves copy of count |
| | on stack. |
| for @b !a+ • unext | \ Waits to read from port R, then stores |
| | \ the data word, and repeats, for the given |
| | payload word count. |
| SerializeOut | \ Calls a Forth word that sends data out |
| | via I/O port. |
| Warm -; | \ places 12f into PAUSE, to await |
| | instructions. |
| . | |

The starting memory address in local memory of computer 12f, wherein the received debug data is temporarily stored (buffered), is duplicated in order to leave a copy of the address on the data stack for use in reading out the data in the next portion of Forth code, which can be a Forth word. In EXAMPLE 3, the Forth word SerializeOut reads the debug data from local memory, converts it to serial form, and sends it out via the I/O port 28 to the user interface system 20. It should be noted that within computers 12 and interconnecting buses 26, the debug data is in 18-bit word format, and it can be transmitted to the host computer 22 of the user interface system over a single wire serial connection, in serial format. Another example of a tail segment operating in computer 12f, in this case, to transmit a continuous stream of debugging data out from chip 14 to the user interface, is shown in EXAMPLE 4.

### EXAMPLE 4

\ tail-segment (continuous recipient, in 12f)

| | |
|---|---|
| ‘R--- # a! | \ Points A-register to receiving port R. |
| ‘iocs # b! | \ Points B-register to port status |
| | register. |
| begin | \ Starts continuous loop |
| @b Pause3 | \ Reads value of port status register, |
| | \ calls 3-port PAUSE to allow cross |
| | \ traffic and external access. |
| @a 18 # SerializeOut | \ Waits to read 18-bit incoming data |
| | \ word, and sends it out in serial |
| | format via the I/O port. |
| again | \ Repeats continuous loop. |
| :Pause3 | \ Defines 3-port PAUSE to execute |
| 2* 2* -if | \ instructions written to port D, port L, |
| drop ; | or port U. |
| then 2* 2* -if | |
| \grave{ }-D-- call | |
| then 2* 2* -if | |
| \grave{ }--L- call | |
| then 2* 2* -if | |
| \grave{ }---U call | |
| then drop ; | \ Discards value of port status register. |

It should be noted that “external access” with reference to PAUSE herein means access to a computer 12 of array 16 via its ports, by the computer executing instructions directly from a port, written to the port by a neighboring computer and alternatively by an external device over an I/O connection. It may be further noted that the tail-segment in EXAMPLE 4 does not store the received debug data locally (as in EXAMPLE 3) but rather sends it out serially via port 28, word by word, as soon as it is received.

Depending on the debugging application, one of several alternate embodiments of a stream segment may be appropriate in an intermediate computer. The main determinants of the stream segment include whether or not there are other instructions operating in the intermediate computer, and whether a single retriever is operating in the array 16 or whether debugging data from a plurality of retriever programs needs to be transmitted and merged. It is anticipated that a stream segment will generally operate under control of a retriever program, waiting for instructions to transmit debugging data. An example of a stream segment operating in intermediate computer 12c, to pass debugging data received along communication path 52 toward computer 12f, assuming that no other instructions are operating in the intermediate computer but, other data besides debugging information can be transmitted through the intermediate computer, through its other ports, is illustrated in EXAMPLE 5, showing intermediate computer 12c waiting in a port read for the incoming debugging data, in this example, from computer 12d, and transmitting it to another intermediate computer 12g, when received.

### EXAMPLE 5

\ stream segment (empty node polling bridge, prioritized or round-robin,
in 12c)

| | |
|---|---|
| ‘--LU # a! | \ Points A-register to multi-port address along path 52. |
| ‘iocs # b! | \ Points B-register to port status register. |
| begin | \ Starts continuous loop |
| @b Pause3 | \ Reads current port status, calls 3-port PAUSE |
| | \ to allow cross traffic and external access though |
| | \ other ports not on 52, and to run a delivery segment |
| | \ from port L along 52 to change the retriever or |
| | target. |
| @a !a | \ Waits to read from two ports, then write to two ports. |
| again | \ Repeats continuous loop. |
| :Pause3 | \ Defines 3-port PAUSE to execute instructions written |
| 2* 2* -if | \ to port R, D, or L. |
| \grave{ }R--- call | |

```
    then 2* 2* -if
    \grave{ }-D--  call
    then 2* 2* -if
    \grave{ }--L-  call
```

| | |
|---|---|
| then drop ; | \ Discards old value of port status register. |

The stream segment program of EXAMPLE 5 operating in computer 12c transmits debugging data through ports L, U along path 52, and allows external access to computer 12c from ports R, D, which are not on the debug communication path 52, and from upstream port L, which is on the communication path. Accordingly, the program can also operate to transmit other data sometimes referred to as cross traffic, through the computer via ports R, D. The stream segment shown can also execute a delivery segment from port L to transmit changes to the retriever and target programs as desired by the user. A substantially similar program can operate in other intermediate computers, with appropriate choice of the multi-port address along a communication path, and appropriate modification of Pause3. Thus the stream segment shown in EXAMPLE 5 can be modified for execution in computer 12g, by changing the multi-port address from '- - LU to 'R- L -, and adapting Pause3 to allow cross traffic and external access through ports D, U, and upstream port R.

In general, transmitting data out serially through an I/O port can take significantly longer than receiving it as 18-bit words over the single drop buses interconnecting the computers of array 16, and can force a real-time target program to “buck” or wait in a PAUSE during a serial transfer out. Long intervals of such waiting between short time periods of debugging data can hide unintended temporary execution halts or loops in a target program that is a real-time application. Thus it is desirable to provide a longer time period over which debugging data can be collected in real time, as quickly as the retriever code in the virtual debug port can generate it, in order to verify and troubleshoot possible problems in the target program that would not otherwise be visible. Accordingly, in an alternate embodiment, a stream segment can queue up (buffer) debugging data transmitted upstream along path 52 from the virtual debug port 10, into larger packets in real time. A way to accomplish that is a FIFO storing and reading-out program, similar to that described in the static recipient tail segment in EXAMPLE 3 that can buffer, for example, 40 words of debugging data, which can be transmitted along path 52 to the peripheral computer, for serial transmission out through an I/O port, to the user interface system. The tail segment operating in a peripheral computer (in this example, computer 12f) can, in one embodiment, combine and buffer, for example, 10 of the larger packets of debugging data, to allow 400 real-time debugging data words (samples) to be gathered before the debugging session is effectively halted, awaiting completion of serial transmission of the data out through the I/O port. In another alternate embodiment of the invention, there can be a plurality of peripheral computers, each executing a tail segment program to transmit a portion of the 400 word packet of debugging data out serially through an I/O port, concurrently in time. In the alternate embodiment the stream segment program in an intermediate computer can be operative to distribute successive 40-word data packets to a plurality of direction ports, sequentially in time, each port connecting to a peripheral computer through suitable other intermediate computers, along a distributed, parallel communication path or portion thereof.

Other versions of the stream segment can be used according to the application, including a stream segment for use with a plurality of retriever programs, that can merge (concatenate) debug data received at two (and alternatively, at three) specified ports, and pass the data to another specified port for transmission along the communication path, toward an I/O port which is connected to the user interface system. In such data merging, tags can be employed for segments of data, to retain identification by source. Yet other stream segment versions can adapt a computer 12g, 12c in which other instructions are operating, to pass debugging data along a communication path; this can be implemented, for example, by inserting extra code into existing data transferring portions of the other instruction, and alternatively, by using a pause loop in the other instructions.

It will be apparent to those skilled in the art that in the alternate embodiment with non-adjacent virtual debug port, shown in FIG. 3 and described hereinabove, a stream segment program similar to that illustrated in EXAMPLE 5 can be used to pass debugging information also between the virtual debug port 10 and target computer 12x, along an extended communication path 54 passing through intermediate computer 12c, as shown in the figure. In still alternate embodiments, such an extended communication path 54 can include a greater number of intermediate computers.

In step 38, shown in FIG. 4, a virtual debug port 10 is formed in computer 12d, by executing the retriever program (head segment) 18. The retriever 18 collects debugging information from the adjacent, neighboring target computer 12e, and makes it available for transmission along the data communication path to the user interface system. The retriever (head segment) program 18, and corresponding appropriate tail, stream, and delivery segments, can be composed, edited, and modified by the software developer, by means of the user interface system 20, to specify the debugging task and the information to be collected in step 38. An embodiment of the retriever program 18 is illustrated in EXAMPLE 6, operating in computer 12d to retrieve the contents of the top of the data stack (also called the T-register) and the top of the return stack (also called the R-register) of computer 12e, at predetermined points (break points) of target program operation, where a PAUSE has been previously included for external access by the virtual debug port. It will be recognized by those familiar with the art that a target application program loaded in step 32 can have appropriate debug-mode instructions, such as calls to a PAUSE subroutine (Forth word), included at the time of initial loading; and alternatively, a call to PAUSE can be inserted at a later time in a debugging session, by a suitable delivery segment as described hereinabove.

### EXAMPLE 6

\ head segment (retriever program, in 12d)
\ This program retrieves the T-register and the R-register upon 12e executing a PAUSE,
\ and the releases 12e to resume target program execution until the next PAUSE.
begin

| | |
|---|---|
| ‘R--- # a! @p+ • | \ Points A-register to address of port R, and |
| !p+ pop !p+ • | \ loads the next instruction word into T-register as data. |
| !a @a @a @p+ | \ Waits to write data word from T-register to port R. |
| | \ After 12e executes PAUSE, it loads the data word from |
| | \ port R to its instruction word register and executes the |
| | \ instructions contained in the data word, to read its |
| | \ T- and R-registers and transmit the values to port R. |
| | \ 12d reads these values from port R and loads them into |
| ; • • • | \ its data stack, then loads the next instruction word into |
| !a ‘---U # a! • | \ T-register as data, and writes it to port R. |
| | \ 12e loads the data word as instructions and executes it |
| | \ to return 12e to the target program. |
| | \ 12d points its A-register to port U, and |
| !a !a @b • | \ transmits the values back along path 52 to tail segment. |
| Pause1 | \ Reads port status register, calls 1-port PAUSE to execute |
| | \ any instructions from port U to change retriever program. |
| again | \ Repeats continuous loop. |

In alternate embodiments, according to the application, a great many versions of a retriever (head segment) program 18 can be used in a virtual debug port 10. The retriever can simply collect port status data by reading the IOCS register according to a modified version of the EXAMPLE 6 program. Alternatively, a retriever can perform single steps of the target program by executing a line-swapping routine. Yet alternatively, a retriever can read registers and memory locations of computer 12e after individually executing the opcode in a particular slot location of an instruction word, by first substituting “no-op” opcodes in the remainder of the slots in the word, in the target application program. Still alternatively, a target program normally resident in two adjacent computers can be downloaded (in step 32) to non-adjacent computers leaving an intermediate computer free for a retriever to be interposed in the communication path between the two computers, to collect the data passed between the two computers during operation of the target program. Yet further alternatively, a retriever can be positioned to feed predetermined input data to a target application, in a debugging session, in place of the input data fed in actual operation, and still further alternatively, a retriever can be positioned in place of an output device receiving data from an output port, to collect and examine the output data.

In step 40, shown in FIG. 4, debugging information collected by retriever program 18 and transmitted back to host computer 22 can be displayed in the graphical user interface window 23, to guide further progress of the debugging session. In one embodiment, the graphical user interface window can display the contents of registers and memory in hex or binary format, for example, by scrolling a display subset of addresses through the memory, and showing fresh and historical data by distinctive color coding. The user can examine and evaluate the debugging information received by the user interface system, and accordingly, a decision can be made in branch step 42 whether the target (software) program will be modified. If yes, appropriate changes to the target program can be formulated by the user with the help of software provided in the user interface system 20. The changes can be downloaded in step 44 and delivered to target computer 12e by a suitable delivery segment as described hereinabove, and operation of the debugging session can loop back along control path 45, to repeat steps 38 through 42. It will be recognized by those familiar with the art that in the operation of a debugging session, the loop via control path 45 represents interactive editing of the target program while examining its operation. Alternatively, at the discretion of the user, the need to modify the target program may be noted but implementing changes and modifications to the target program can be deferred while more information can be collected via step 46 and path 47. The method of debugging using the virtual debug port, according to the invention, is not limited by a particular order in which debugging information is collected and examined, and changes and modifications are made to a target program.

If no change is made in the target program, operation will continue to branch step 46, wherein new debugging data can be requested by changing the retriever program 18, using suitable software included in the user interface system, and then operation can loop back along control path 47 to repeat the steps 34 through 46. It should be noted that a wide range of changes can be potentially made to retriever 18 in a branch step 46, including requesting different information from the same target computer via the same virtual debug port, and further, debugging a different target program portion that is resident in another target computer of the array. The new (changed) retriever 18 can be delivered to array 16, in step 34, by a suitable delivery segment, as described hereinabove. The debugging session will terminate in end step 48 if no new debugging information is requested in branch step 46.

It is apparent that according to the invention, the retriever 18 can interact directly with the target computer 12e on chip 14 and with the user interface system 20 on host computer 22, and can operate in conjunction with both. In relation to chip 14, computer 12d, while executing retriever program 18, essentially acts as, and provides the same capabilities as a dedicated debugging circuit and interface, and a debugging monitor to the adjacent computer 12e; in short, computer 12d assumes the role of a virtual debug port 10 on chip 14. Owing to the communication capabilities of the computers 12 with each other, the retriever program 18 can be placed in, or moved to, any computer 12 in array 16, as specified from the host computer 22 by the user, by means of suitable software therein provided, and as directed internally by suitable instructions within the delivery segment. Accordingly, with respect to target computers that are not on the periphery of the chip 14 and are not provided with external communication ports, any of the computers 12 can take the role of a virtual debug port 10 and provide the same information as a plurality of custom external connections, as in a bond-out chip.

The invention is described hereinabove with reference to embodiments using the Forth™ computer language, for illustrative purposes, not meant to be limiting. It should be noted that the invention can be practiced with equal effect in alternate embodiments using other suitable computer languages, for example C++, C#, and appropriate compiled object code suitable for the computers of a multiprocessor chip employed in the embodiment.

It will be apparent to those familiar with the art that in yet an alternate embodiment, the hardware portion that is the smallest repeated element of array 16 on chip 14 may have a form that is different from a dual-stack computer with RAM and ROM memory, without departing from the spirit and scope of the invention. While in the embodiments described hereinabove, the smallest repeated hardware portion of chip 14 (and array 16) is a computer 12, in an alternate embodiment the smallest repeated hardware portion can be, for example, a software-configurable set of computation, communication and memory resources, and sometimes also called a digital cell, internally connected for example, through a switch, and directly connected to adjacent, neighboring hardware portions by single-drop buses, and further, adaptable by means of appropriate (system-level) instructions, suitably interleaved with application software instructions, to appear to application software as a fully functioning computer with its own memory, and alternatively, as a more limited computation, communication or memory resource, according to the application software instructions executing in a particular hardware portion location in the array, on the chip—such that, by appropriate software (instructions), a hardware portion can be configured (adapted) to operate as a virtual debug port 10, according to the invention. It will be further apparent that the invention can be practiced in computer systems with still other suitable parallel-distributed structure at the hardware level.

### INDUSTRIAL APPLICABILITY

The inventive computer arrays 16, computers 12, port 28, virtual port 10 and virtual port method of FIG. 4 and Examples 1-6 are intended to be widely used in a great variety of computer applications. It is expected that they will be particularly useful in applications where significant computing power is required, and yet power consumption and heat production are important considerations.

As discussed previously herein, the applicability of the present invention is such that the sharing of information and resources between the computers in an array is greatly enhanced, both in speed a versatility. Also, communications between a computer array and other devices is enhanced according to the described method and means.

Since computer arrays 16, computers 12, port 28, virtual port 10 and virtual port method of FIG. 4 and Examples 1-6 of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long lasting in duration.

### REFERENCE CHARACTER LIST

NOTICE: This reference character list is provided for informational purposes only, and it is not a part of the official Patent Application.
10 virtual debug port
12 computer (processor, node, hardware portion)
14 chip, microchip
16 array, multiprocessor array
18 retriever program, head segment
20 (external) user interface system
22 host computer, PC
23 graphical user interface window
24 processor board
26 single-drop bus
28 input/output port
30 sequence of steps
32, 34, 38, 40, 44 step (of operation)
42, 46 branch step
45, 47 control path
48 end step
52 communication path
54 extended communication path

1. A virtual debug port in a single-chip computer system, for transmitting and receiving information between a target hardware portion of the system and an external user interface, for debugging of software operating in the target:
wherein the system has a parallel-distributed structure at the hardware level comprising a plurality of substantially similar hardware portions disposed as an array on one microchip; and
wherein the debug port is formed by a retriever program of instructions operating in at least one of the plurality of substantially similar hardware portions; and
wherein the debug port is operative to transmit and receive debugging information to and from the target.

2. The virtual debug port of claim 1, wherein the substantially similar hardware portions are interconnected and communicate by single-drop buses between adjacent neighboring hardware portions and there is no common bus for individually addressing the portions.

3. The virtual debug port of claim 2, wherein the virtual debug port is disposed, on the microchip, adjacent to and neighboring the target hardware portion.

4. The virtual debug port of claim 2, wherein the substantially similar hardware portions are computers, each computer having processing capabilities and at least some dedicated memory.

5. The virtual debug port of claim 4, wherein the computers employ a dual-stack design, have individual ROM and RAM memory, and are adapted to execute instructions from a neighboring computer.

6. The virtual debug port of claim 5, wherein the computers are further adapted to execute native Forth™ language instructions and to use Forth™ words, dictionaries of Forth™ words, and forthlets.

7. The virtual debug port of claim 2, wherein the substantially similar hardware portions are software-configurable sets of computation, communication and memory resources.

8. The virtual debug port of claim 3, further including communication software portions operating in other hardware portions of the plurality of substantially similar hardware portions, disposed in a communication path between the virtual debug port and an I/O port of the microchip, for transmitting and receiving information between the virtual debug port and the external user interface.

9. The virtual debug port of claim 2, further including communication software portions operating in other hardware portions of the plurality of substantially similar hardware portions, disposed in a communication path between the virtual debug port and an I/O port of the microchip, and in a second communication path between the virtual debug port and the target hardware portion, for transmitting and receiving debug information between the target hardware portion and the external user interface.

10. A method of operating a parallel-distributed computer system including a plurality of substantially similar hardware portions disposed as an array on one microchip, comprising the steps of; loading a target program to be debugged into at least one of the plurality of hardware portions, and, delivering communication programs and a retriever program to others of the plurality of hardware portions, which are disposed in a path connecting the hardware portion storing the retriever to an I/O port and an external user interface, wherein the retriever program is adapted to retrieve contents information of registers and memory of the one hardware portion, at predetermined points of target program operation, and, wherein the communication programs are adapted to transmit the contents information to the user interface for debugging of the target program, and, operating the target program, retriever program, and communication programs, to retrieve the contents information and transmit it to the external user interface, to debug the target program.

11. A method of operating a parallel-distributed computer system as in claim 10, further comprising the steps of; displaying the contents information to facilitate examination and evaluation of the information by the user; deciding to modify or not modify the target program; delivering target program changes; and repeating the steps beginning with operating the target program and retrieving the contents information, and, changing the retriever program and repeating the steps beginning with delivering communication programs and a retriever program.

12. A method of operating a parallel-distributed computer system as in claim 10, wherein the substantially similar hardware portions are interconnected and communicate by single-drop buses between adjacent neighboring hardware portions and there is no common bus for individually addressing the portions.

13. A method of operating a parallel-distributed computer system as in claim 12, wherein the substantially similar hardware portions are computers, each computer having processing capabilities and at least some dedicated memory.

14. A method of operating a parallel-distributed computer system as in claim 14, wherein the computers employ a dual-stack design, and have individual ROM and RAM memory, and are configured to execute instructions from a port.

15. A method of operating a parallel-distributed computer system as in claim 14, wherein the computers further are adapted to execute native Forth™ language instructions and to use Forth™ words, dictionaries of Forth™ words, and forthlets.

16. A method of operating a parallel-distributed computer system as in claim 11, wherein the substantially similar hardware portions are software-configurable sets of computation, communication and memory resources.

17. A method of operating a parallel-distributed computer system as in claim 11, wherein another hardware portion is disposed adjacent to and neighboring the one hardware portion.

18. A method of operating a parallel-distributed computer system as in claim 11, further including the steps of; delivering extended communication programs to yet others of the plurality of hardware portions disposed in an extended communication path connecting the one hardware portion and the hardware portion storing the retriever, which are not disposed adjacent to and neighboring each other, the communication programs being adapted to retrieve and transmit the contents information from the one hardware portion to the hardware portion storing the retriever, and operating the extended retriever communication programs with the target program, retriever program, and communication programs, to retrieve the contents information and transmit it to the external user interface, to debug the target program.

19. A computer-readable medium having a retriever program sequence of instructions stored thereon which, when executed by a hardware portion of a single-chip computer system, cause the hardware portion to transmit and receive information between a target hardware portion of the system and another hardware portion, wherein the information relates to operation and debugging of a target program of instructions in the target hardware portion; and wherein the system has a parallel-distributed structure at the hardware level comprising a plurality of substantially similar hardware portions disposed as an array on one microchip; and wherein the retriever program operates in at least one of the plurality of substantially similar hardware portions, not including the target, for transmitting and receiving debugging information to and from the target.

20. A computer-readable medium having a retriever program sequence of instructions as in claim 19, further including communication software portions operating in other hardware portions of the plurality, which are disposed in a communication path between the one hardware portion and an I/O port of the microchip, for transmitting and receiving debugging information between the retriever program and an external user interface.
